(19) United States
(12) Patent Application Publication
(10) Pub. No.: US 2006/0186050 A1
(43) Pub. Date: Aug. 24, 2006

(54) Devices and processes for removal of impurities from a fluid recovered from a subterranean environment

(75) Inventors: Robert E. Hanes JR., Oklahoma City, OK (US); David E. Griffin, Marlow, OK (US); David E. McMechan, Duncan, OK (US)

Correspondence Address: Robert A. Kent, 2600 S. 2nd Street, Duncan, OK, 73536-0440, US

(73) Assignee: Halliburton Energy Services, Inc.

(21) Appl. No.: 11/062,963

(22) Filed: Feb. 22, 2005

(51) Int. Cl. C02F 1/42

(52) U.S. Cl. 210/670

(57) ABSTRACT

Processes are provided for removing impurities from a fluid recovered from a subterranean environment. An example of a process for removing an inorganic impurity from a recovered fluid includes providing a filter media, the filter media comprising an adsorbent material; flowing the recovered fluid that comprises the inorganic impurity through the filter media; and removing at least a portion of the inorganic impurity from the recovered fluid to form a filtered fluid.

### BACKGROUND

The present invention relates to the removal of impurities from a fluid, and more particularly, to devices and processes for removing impurities from a fluid recovered from a subterranean environment.

Fluids recovered from subterranean environments such as oil and gas wells (herein, “recovered fluids”) often include undesirable impurities. The presence of impurities in a recovered fluid may be problematic for the environmental disposal of the recovered fluid, or may be undesirable for subsequent uses of the recovered fluid. Often, additional treatment processes are required to make recovered fluids acceptable for other subsequent uses or for environmental disposal.

Examples of impurities contained in recovered fluids include metals, metal ions, crosslinking agents, and other inorganic impurities. Removal of these impurities has often been accomplished through processes, such as osmosis, ion exchange, electrolysis, and other high-energy intensive processes. These processes, however, have drawbacks. In particular, some of these processes may be chemically intensive, which may entail further environmental disposal problems, thereby potentially increasing the cost of such processes. The processes heretofore used often have resulted in a higher cost due to either the high energy requirements of the process or the chemically intensive nature of the process.

Other problems with the removal of impurities from recovered fluids include the lack of available devices or processes that can be used onsite to remove impurities from recovered fluids. With conventional techniques, recovered fluids must often be transported at a high cost to a treatment facility to remove the impurities so that the recovered fluid can be disposed of or applied to another use.

### SUMMARY

The present invention relates to the removal of impurities from a fluid, and more particularly, to devices and processes for removing impurities from a fluid recovered from a subterranean environment.

An example of a process of the present invention for removing an inorganic impurity from a recovered fluid comprises providing a filter media, the filter media comprising an adsorbent material; providing a housing, the filter media being positioned within the housing; providing at least one connection to the housing so that the recovered fluid may enter the housing in at least one entrance and exit the housing out of at least one exit; flowing the recovered fluid that comprises the inorganic impurity through the filter media; and removing at least a portion of the inorganic impurity from the recovered fluid to form a filtered fluid.

Another example of a process of the present invention for removing an inorganic impurity from a recovered fluid comprises providing a filter media, the filter media comprising an adsorbent material; flowing the recovered fluid that comprises the inorganic impurity through the filter media; and removing at least a portion of the inorganic impurity from the recovered fluid to form a filtered fluid.

The objects, features, and advantages of the present invention will be readily apparent to those skilled in the art upon a reading of the description of preferred embodiments which follows.

### DRAWINGS

A more complete understanding of the present disclosure and advantages thereof may be acquired by referring to the following description taken in conjunction with the accompanying drawings, wherein:

FIG. 1 illustrates an impurity removal device in accordance with an embodiment of the present invention.

FIG. 2 illustrates a recovered fluid flowing through a filter media to remove impurities from the recovered fluid in accordance with an embodiment of the present invention.

FIG. 3 illustrates a system for removing an impurity from a recovered fluid shown in a parallel configuration in accordance with an embodiment of the present invention.

FIG. 4 illustrates a filter media fluidly coupled to additional filter media in accordance with an embodiment of the present invention.

FIG. 5 illustrates a recovered fluid flowing through a filter media fluidly coupled to optional additional impurity removal processes in accordance with an embodiment of the present invention.

FIG. 6 graphical depicts experimental data showing the flow rate through a filter cell versus differential pressure across the filter cell.

While the present invention is susceptible to various modifications and alternative forms, some embodiments thereof have been shown in the drawings and are herein described. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION

The present invention relates generally to the removal of impurities from a fluid, and more particularly, to devices and processes for removing impurities from a fluid recovered from a subterranean environment.

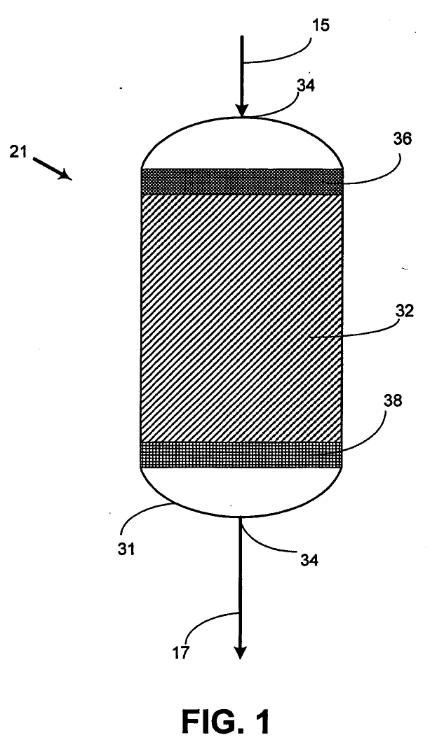

FIG. 1 illustrates an impurity removal device 21 for removing impurities from a recovered fluid 15 incorporating features in accordance with one embodiment of the present invention. In one embodiment, a recovered fluid 15 comprising an inorganic impurity flows through a filter media 32 to form a filtered fluid 17. The filter media 32 may be contained within a housing 31. Additionally, in certain embodiments, a distributor element 36 may be fluidly coupled to the filter media 32 upstream of the filter media 32. Further, in certain embodiments, a support element 38 may be fluidly coupled to the filter media 32 downstream of the filter media 32.

The housing 31 may be made of any material capable of withstanding the pressures subjected to it by the contained fluid (e.g., the recovered fluid 15), and at the same time, preferably not introduce any undesirable components into the fluid. In certain embodiments, the housing 31 may be constructed of stainless steel. Further, the housing 31 may have one or more connections 34 allowing recovered fluid 15 to enter and exit the housing 31.

In certain embodiments, a distributor element 36 may be provided upstream of the filter media 32. The distributor element 36 may assist in distributing the recovered fluid 15 entering the filter media 32 such that the recovered fluid 15 enters the filter media 32 more evenly distributed. In this way, channeling through the filter media 32 may be minimized. In certain embodiments, the distributor element 36 may comprise a sand screen.

In certain embodiments, a support element 38 may be provided downstream of the filter media 32. The support element 38 allows the recovered fluid 15 to exit the housing 31 while at the same time substantially preventing the passage of the filter media 32. The support element 38 may also provide support to the filter media 32 in certain embodiments. The support element 38 may comprise a screening surface or any suitable material that permits the passage of fluid but substantially prevents the passage of the filter media 32. In certain instances, the screening surface may have any mesh size from 20/40 mesh to 60/200 mesh, and in certain exemplary embodiments, 30/60 mesh.

Although FIG. 1 depicts a distributor element 36 and a support element 38 located within a housing 31, the distributor element 36 and/or the support element 38 may be situated outside the housing 31 in certain embodiments.

The recovered fluid 15 may be any fluid extracted from a subterranean environment by any suitable means, including, but not limited to, natural pressure gradients, artificially assisted extraction techniques, or combinations thereof. The recovered fluid 15 may comprise a naturally occurring formation fluid, a fluid previously introduced into a subterranean environment, or a mixture thereof. In certain embodiments, the recovered fluid 15 may be extracted from a multi-phase fluid, a substantially single phase fluid, or a mixture thereof. Examples of recovered fluids for use with the present invention include, but are not limited to, any combination of drilling fluids, spacer fluids, stimulation fluids, treatment fluids, well-completion fluids, well-control fluids, artificially stored fluids, and naturally occurring formation fluids.

The filter media 32 of the devices and processes of the present invention may comprise any adsorbent material. Adsorbent materials may be natural or synthetic materials of amorphous or microcrystalline structure. By way of example, those adsorbent materials used on a large scale include activated carbon, activated alumina, silica gel, fuller's earth, other clays, molecular sieves, or a combination thereof. In certain embodiments, the adsorbent filter media 32 may comprise a cellulose material, a cellulose-based material, a cellulose material derived from cellulose pulp, or a combination thereof. Certain embodiments of the cellulose-based material may comprise a microcrystalline cellulose, a powdered or granular cellulose, a colloidal cellulose, a surface-modified cellulose, or any insoluble cellulose. Certain embodiments of the cellulose-based material may include chemically unmodified forms of cellulose including, but not limited to, saw dust, wood shavings, and compressed wood particles. Additionally, chemically modified cellulose derivatives may be used including, but not limited to, materials capable of being ion exchanged such as, for example, phosphonate cellulose, methylene carboxylate cellulose, ethyl trimethyl ammonium cellulose, triethyl hydroxypropyl ammonium cellulose, aminoethyl cellulose, diethyl aminoethyl cellulose, or combinations thereof. Additional ion exchange resin media include, but are not limited to, ion exchange resins sold under the trademarks, Amberlite®, Dowex®, and Sephadex®, all of which are commercially available from Sigma-Aldrich Company, St. Louis, Mo. The specific type and amount of filter media depends on a number of factors including the concentration and type of impurities to be removed. A person of ordinary skill in the art with the benefit of this disclosure would appreciate the amount and type of filter media appropriate for a given application.

Impurities to be removed from the recovered fluid 15 may be any inorganic impurity including, but not limited to, a metal, a metal ion, crosslinking agents, boron, any boron-based compounds, or any mixture thereof. In those instances in which the impurity comprises a crosslinking agent, the crosslinking agent may originate from fluids introduced into a subterranean environment such as treatment fluids. Crosslinking agents may be used to crosslink gelling agent molecules to form a more viscous mixture. Crosslinking agents typically comprise at least one ion that is capable of crosslinking at least two gelling agent molecules. Examples of suitable crosslinking agents include, but are not limited to, compounds that can supply borate ions (such as, for example, boric acid, disodium octaborate tetrahydrate, sodium diborate, pentaborates, ulexite and colemanite); compounds that can supply zirconium IV ions (such as, for example, zirconium lactate, zirconium lactate triethanolamine, zirconium carbonate, zirconium acetylacetonate, zirconium malate, zirconium citrate, and zirconium diisopropylamine lactate); compounds that can supply titanium IV ions (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; or a combination thereof.

In certain embodiments, the recovered fluid 15 may further comprise organic gelling agents or hydrocarbons that may be removed in conjunction with the inorganic impurities being removed. Organic gelling agents that may be present in the recovered fluid include, but are not limited to, galactomannan gums, cellulose, biopolymers (e.g., xanthan gums, scleroglucan, succinoglycan, etc.), and derivatives thereof.

The removal of impurities from the recovered fluid 15 by the filter media 32 may occur by a variety of separation mechanisms including, but not limited to, adsorption of the impurity onto the filter media 32, physical separation, ion-exchange, chelation, or any other suitable separation mechanism which results in a removal of the impurity from the recovered fluid 15.

In one embodiment of the present invention, which incorporates certain features illustrated in FIG. 1, a process for removing an impurity from a recovered fluid may comprise providing a filter media, the filter media comprising an adsorbent material; providing a housing, the filter media being positioned within the housing; providing at least one connection to the housing so that the recovered fluid may enter the housing in at least one entrance and exit the housing out of at least one exit; flowing the recovered fluid through the filter media; removing at least one inorganic impurity from the recovered fluid to form a filtered fluid; and recovering the filtered fluid.

Flowing the recovered fluid 15 through the filter media 32 may be accomplished by gravity flow or in certain embodiments, through an assisted flow mechanism such as, for example, pumping the recovered fluid 15 through the filter media 32.

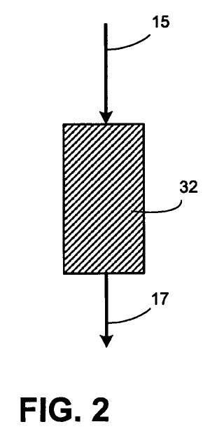

In accordance with the devices and processes of the present invention, FIG. 2 illustrates a recovered fluid 15 flowing through a filter media 32 to remove at least one inorganic impurity from the recovered fluid 15 to form a filtered fluid 17.

In one embodiment of the present invention, a process for removing an inorganic impurity from a recovered fluid may comprise providing a filter media, the filter media comprising an adsorbent material; flowing the recovered fluid through the filter media; and removing at least one inorganic impurity from the recovered fluid to form a filtered fluid.

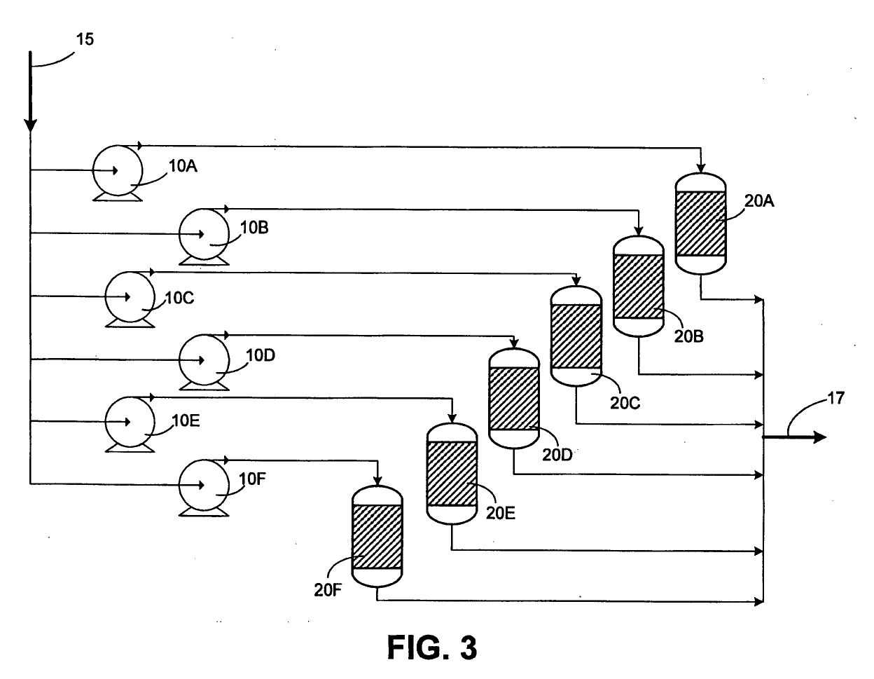

FIG. 3 illustrates a system for removing an impurity from a recovered fluid shown in a parallel configuration in accordance with an embodiment of the present invention. Pumps 10A-10F pump the recovered fluid 15 through impurity removal devices 20A-20F to form a filtered fluid 17. While FIG. 3 depicts six impurity removal devices 20A-20F in parallel, any number of impurity removal devices may be fluidly connected in series, in parallel, or in any combination thereof, in accordance with the present invention. Preferred embodiments may include multiple impurity removal devices.

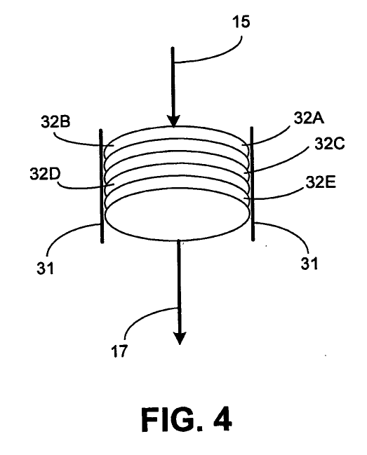

FIG. 4 illustrates a filter media 32 fluidly coupled to additional filter media in accordance with an embodiment of the present invention. In this embodiment, an activated carbon filter media 32A is shown upstream of a silica gel filter media 32B, which is in turn upstream of a cellulose based filter media 32C, which is yet in turn upstream of an anion exchange filter media 32D, which is yet in turn upstream of a cation exchange filter media 32E. As will be readily apparent to one skilled in the art with the benefit of this disclosure, the additional filter media depicted in FIG. 4 may be arranged in any sequence and is not limited to the order depicted here. Although, five filter media are depicted here, one skilled in the art with the benefit of this disclosure will appreciate that the additional filter media may be present in any combination and that the present invention is not limited to a specific number of additional filter media. Further, one skilled in the art with the benefit of this disclosure will appreciate that the additional filter media depicted here may be situated outside of the housing 31 as well. Additionally, in certain embodiments, the processes of the present invention may be located on-site at an oil and gas well site.

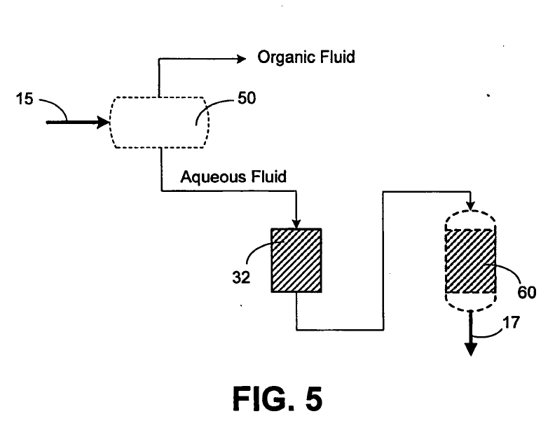

FIG. 5 illustrates a recovered fluid flowing through a filter media 32, fluidly coupled to optional additional impurity removal processes 50 & 60 in accordance with an embodiment of the present invention. One optional impurity removal process 50 comprises a gravity separation device or process and is upstream of the filter media 32 along with another optional impurity removal process 60 depicted downstream of the filter media 32. Although here, the additional impurity removal processes are depicted in a specific order, these optional impurity removal processes 50 & 60 may be placed upstream or downstream of the filter media 32. Further, these additional impurity removal processes 50 & 60 may be configured in parallel, in series, or in any combination thereof to the filter media 32. In the case of a gravity phase separation process, the additional impurity removal process may comprise separating an aqueous phase from an organic phase via a gravity phase separation. In certain embodiments, the additional impurity removal processes may include flowing a recovered fluid 17 through any of the following: a screening surface, a coarse filter media, an activated carbon filter media, a silica gel filter media, an ion exchange resin media, a chelating filter media, an osmosis impurity removal process, or an electrolysis impurity removal process. Examples of additional ion exchange resin media include, but are not limited to, ion exchange resins sold under the trademarks, Amberlite® (trademark owned by Rohm and Haas Co., Philadelphia, Pa.), Dowex® (trademark owned by Dow Chemical Co., Midland, Mich.) and Sephadex® (trademark owned by Amersham Biosciences, Uppsala, Sweden), all of which are commercially available from Sigma-Aldrich Company, St. Louis, Mo. Examples of chelating filter media include, but are not limited to, crown ether resins, polyether resins, and calixarenes.

In certain embodiments, a process for removing impurities from a recovered fluid may include regenerating the filter media such that the filter media may be reused. This regeneration may be accomplished via a rinsing step using a rinsing fluid. In certain embodiments, the rinsing fluid may comprise a water, a base, or an acid.

In certain embodiments, the impurity removal process may include testing the filtered fluid downstream of a filter media to evaluate a removal efficiency of the filter media or to determine the level of residual impurity in the water. Any suitable method may be used to determine the concentration of impurity in the water effluent including, but not limited to, a gravimetric analysis or a colorimetric analysis. In certain embodiments, the impurity removal process may be continued until the concentration of impurity is reduced to a desired residual concentration of impurity in the filtered fluid. The desired level of impurity reduction may differ depending upon the subsequent intended use of the filtered fluid. Subsequent uses of the filtered fluid may include, for example, a well bore treatment fluid, an agricultural use, a subsequent industrial use, or simply an environmentally sound disposal of the filtered fluid.

In certain embodiments, a slurry of adsorbents may be added to the recovered fluid including, but not limited to, cellulose, activated carbon, silica gel, or any mixture thereof. Circulation of the adsorbents, followed by coarse filtration would be appropriate during conditions obvious to one skilled in the art with the benefit of this disclosure.

Additionally, a treatment chemical could be added to facilitate the treatment process, such as the addition of a base. Among other things, the treatment chemical may elicit a precipitation and/or chemical reactions to degrade some of the impurities. In certain embodiments, the base may be sodium hydroxide.

To facilitate a better understanding of the present invention, the following examples of certain embodiments are given. In no way should the following examples be read to limit, or define, the scope of the invention.

### EXAMPLE 1

One gallon of water recovered from a subterranean environment was filtered through a vertical column charged with 2.5 cubic inches of activated carbon, 5.3 cubic inches of cellulose material, and 5.3 cubic inches of silica gel media. The water was forced through the vertical column using pressurized nitrogen. Samples of both the unfiltered water and the effluent filtered water were analyzed. The sample results are summarized in Table 1.

TABLE 1

| Measured | Unfiltered | Filtered |
|---|---|---|
| Specific Gravity | 1.008 | 0.996 |
| pH | 4.42 | 7.25 |
| Resistivity, ohms-cm | 48.5 | 250.7 |

Concentration, mg/L

| | | |
|---|---|---|
| OH | — | 236.00 |
| CO₃ | — | 162.00 |
| HCO₃ | 0.0 | 46 |
| B | 11.8 | 0.21 |
| Cl | 7090 | 1190 |
| SO₄ | 26 | 38 |
| Ca | 619 | 130 |
| Mg | 45.1 | 13.06 |
| Ba | 0.14 | BDL¹ |
| Sn | 40.0 | 0.13 |
| Fe | 11.00 | <0.01 |
| K | 312 | 47.05 |
| Na | 3433 | 681.0 |
| Al | <0.05 | <0.01 |
| TDS² | 11600 | 2142 |
| TOC³ | 40.45 | 9.46 |

¹BDL: Below detection limit
²TDS: Total dissolved solids
³TOC: Total organic carbon

Thus, Table 1 indicates that an impurity removal process of the present invention may be suitable to remove inorganic impurities from a recovered fluid.

### EXAMPLE 2

In a separate experiment, 500 ppm of boric acid was added to a distilled water sample. This sample was filtered at a rate of one liter per minute through a vertical column, 1.5 inches in diameter, charged with 14 cubic inches of cellulose pulp (Chemical Abstracts Service number 9004-34-6). The filtrate was analyzed using a colorimetric technique using a known boron chelator that results in a color change measurable using Beer's Law. The filtered sample possessed a boron content below the detection limit of the instrument.

### EXAMPLE 3

To determine flow rates through a filter media bed, a filter cell with a diameter of 18 inches and a height of 3.5 ft was packed with 2 liters of coarse mesh sand, 1 liter of 50/70 mesh sand, 5 kg of cellulose microcrystalline powder, 2.5 kg of silica gel, and 1 kg of activated carbon. The filter media components listed above, with the exception of the coarse mesh sand, are commercially available from Sigma-Aldrich Company, St. Louis, Mo. Flow rates through the filter cell were measured at different differential pressures across the filter cell. Additionally, flow rates were also measured with other filter cells added in parallel.

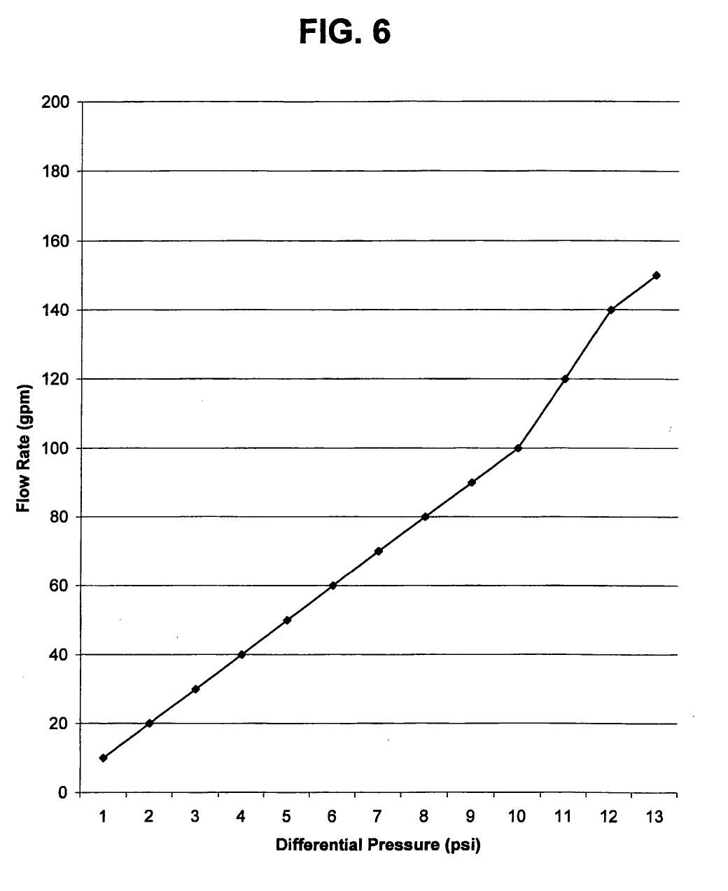

Table 2 shows the relationship between flow rate through the filter cell along with corresponding measurements of differential pressure across the filter cell. FIG. 6 shows the data from Table 2 in the form of a line graph.

TABLE 2

| Flow Rate Measured | Differential Pressure |
|---|---|
| Through Filter Cell | Measured Across the |
| (gpm) | Filter Cell (psi) |
| 10 | 0.03 |
| 20 | 0.05 |
| 30 | 0.08 |
| 40 | 0.11 |
| 50 | 0.14 |
| 60 | 0.16 |
| 70 | 0.19 |
| 80 | 0.22 |
| 90 | 0.24 |
| 100 | 0.27 |
| 120 | 0.33 |
| 140 | 0.38 |
| 150 | 0.41 |

Thus, the present invention is well adapted to carry out the objects and attain the ends and advantages mentioned as those which are inherent therein. While numerous changes may be made by those skilled in the art, such changes are encompassed within the spirit and scope of this invention as defined by the appended claims.

What is claimed is:

1. A process for removing an inorganic impurity from a recovered fluid comprising:
providing a filter media, the filter media comprising an adsorbent material;
providing a housing, the filter media being positioned within the housing;
providing at least one connection to the housing so that the recovered fluid may enter the housing in at least one entrance and exit the housing out of at least one exit;
flowing the recovered fluid that comprises the inorganic impurity through the filter media; and
removing at least a portion of the inorganic impurity from the recovered fluid to form a filtered fluid.

2. The process of claim 1 wherein the filter media comprises at least one of the following: a cellulose material, a cellulose-based material, a cellulose material derived from cellulose pulp, or a mixture thereof.

3. The process of claim 2 wherein the cellulose material comprises at least one of the following: a microcrystalline cellulose, a powdered cellulose, a granular cellulose, a colloidal cellulose, a surface-modified cellulose, an insoluble cellulose, or any mixture thereof.

4. The process of claim 2 wherein the inorganic impurity comprises at least one of the following: a metal, a metal ion, a crosslinking agent, boron, a borate releasing compound, or a mixture thereof.

5. The process of claim 3 wherein the recovered fluid further comprises an organic impurity and the process further comprising:
removing at least a portion of the organic impurity from the recovered fluid

6. The process of claim 1 wherein the process is located on-site at an oil and gas well site.

7. The process of claim 1 further comprising providing a support element fluidly coupled to the filter media downstream of the filter media.

8. The process of claim 1 further comprising providing a distributor element fluidly coupled to the filter media upstream of the filter media.

9. The process of claim 8 wherein the distributor element comprises a sand-screen.

10. The process of claim 1 further comprising rinsing the filter media with a rinsing fluid to regenerate the filter media.

11. The process of claim 10 wherein the rinsing fluid comprises at least one of the following: a water, a base, or an acid.

12. The process of claim 1 further comprising testing the filtered fluid downstream of the filter media to evaluate a removal efficiency of the filter media.

13. The process of claim 1 further comprising:
providing an additional impurity removal process fluidly coupled to the filter media; and
flowing the fluid through the additional impurity removal process.

14. The process of claim 13 wherein the additional impurity removal process further comprises separating an aqueous phase from an organic phase via a gravity phase separation.

15. The process of claim 13 wherein the additional impurity removal process comprises at least one of the following: a screening surface, a coarse filter media, an activated carbon filter media, a silica gel filter media, an ion exchange resin media, a chelating filter media, an osmosis impurity removal process, an electrolysis impurity removal process, or a combination thereof.

16. The process of claim 1 further comprising:
providing a support element fluidly coupled to the filter media downstream of the filter media;
providing a distributor element fluidly coupled to the filter media upstream of the filter media;
wherein the flowing of the recovered fluid through the filter media is accomplished by at least one pump;
wherein the recovered fluid comprises an aqueous fluid;
wherein the filter media comprises at least one of the following: a cellulose material, a cellulose-based material, a cellulose material derived from cellulose-pulp, or a mixture thereof; and
wherein the impurity to be removed comprises at least one of a metal, a metal ion, a crosslinking agent, boron, a borate releasing compound, or a mixture thereof.

17. A process for removing an inorganic impurity from a recovered fluid comprising:
providing a filter media, the filter media comprising an adsorbent material;
flowing the recovered fluid that comprises the inorganic impurity through the filter media; and
removing at least a portion of the inorganic impurity from the recovered fluid to form a filtered fluid.

18. The process of claim 17 wherein the filter media comprises at least one of the following: a cellulose material, a cellulose-based material, a cellulose material derived from cellulose pulp, or a mixture thereof.

19. The process of claim 17 wherein the impurity comprises at least one of the following: a metal, a metal ion, a crosslinking agent, boron, a borate releasing compound, or a mixture thereof.

20. The process of claim 17 wherein the recovered fluid further comprises an organic impurity and the process further comprising:
removing at least a portion of the organic impurity from the recovered fluid.
